(19) United States
(12) Patent Application Publication
(10) Pub. No.: US 2015/0370060 A1
(43) Pub. Date: Dec. 24, 2015

(54) MICROSCOPE SLIDE WITH ETCHED SHAPES

(71) Applicant: Resolution Biomedical, Inc., Tustin, CA (US)

(72) Inventors: Donald Williams, Newport Beach, CA (US); Michael Friedl, Laguna Hills, CA (US)

(21) Appl. No.: 14/744,387

(22) Filed: Jun. 19, 2015

Related U.S. Application Data
(60) Provisional application No. 62/016,018, filed on Jun. 23, 2014.

(51) Int. Cl. G02B 21/34; G01N 1/28; G01N 1/32; G02B 21/00

(52) U.S. Cl. CPC G02B 21/34; G02B 21/002; G01N 1/2813; G01N 1/32

(57) ABSTRACT

A microscope slide which is treated to provide frosted or etched channels that define a geometric shape on both sides of the slide. The channels on one side of the slide provide a border to retain the specimen, cells, or fluid and limit the normal distribution of cells in a single, monolayer, and the channels on one side of the slide provide a visual aid to the cytological analysis. The slides and method of use thereof provide a reduction of the focal layers needed for imaging of cell samples, as compared to currently known slides.

### CROSS-REFERENCE TO RELATED APPLICATIONS

This application claims the benefit of priority from U.S. Provisional App. No. 62/016,018 filed on Jun. 23, 2014, which application is incorporated herein by reference in its entirety. Any and all applications for which a foreign or domestic priority claim is identified in the Application Data Sheet as filed with the present application are hereby incorporated by reference under 37 CFR 1.57.

### BACKGROUND

1. Field

Embodiments of the invention are generally directed to microscope slides (or plates) for use in cytology and, more particularly, to microscopic slides having a portion of both the upper (or first) and lower (or second) surfaces treated so as to create etched channels in patterns of geometric shapes (for example, a circle, an oval, a square, a rectangle, a hexagon, etc.) of specific dimensions. Some embodiments of the invention are directed to microscope slides; some embodiments are directed to assemblies of such a slide, a sample containing cells, and a cover slip; some embodiments are directed to methods for visualizing cells or for the detection of cancerous cells in the field of cytology, using slides having etched shapes on both sides of the slide; some embodiments are directed to methods of manufacturing such slides; and some embodiments are directed to methods of using of such slides.

2. Description of the Related Art

In a wide variety of diagnostic assays, the ability to image, with a particular limited number of focal zones/planes, slides with material, typically cells, cellular matter, and particulate matter, can be important for the enablement of testing for the presence or absence of substances and other diagnostic materials contained in the sample. Oftentimes, sample preparation obscures the target matter by providing multiple layers of sample material, decreasing the utility of the sample for detection and/or diagnostic analysis. Such shortcomings are particularly acute in the field of cytological examinations, where multiple layers of cells, cellular structures, and related components vital to useful diagnostic examination are obscured on a microscope slide.

Cytological examination of a sample of cells typically begins with a step of obtaining a specimen (or a plurality of specimens) of cells and/or related material from a subject or host. Obtaining one or more samples of cells may be accomplished by brushing, scraping, or swabbing a body area, as in the case of cervical, oral, and anal specimens, or by collecting body fluids such as urine, blood, or plasma, or by collecting fluids from such body areas as the bladder, vaginal cavity, anal cavity, oral cavity, chest cavity, or spinal column, or by fine needle aspiration or fine needle biopsy of those and/or other areas of the body, or by other sample collection techniques known to those of skill in the art. A significant challenge for such cytological preparations is presenting substantially a single layer of cells, substantially a bi-layer, or substantially a consistent, limited number of layers of cells on a microscope slide for visual imaging and/or diagnostic analysis of the sample. Diagnostic accuracy of both microbiologic and cytologic assays depends heavily on microscopic examination of cells, cellular structures, and related materials. Thus, it is desirable to present the sample in one or a limited number of focal levels. Such presentation results in faster, more accurate, and focused imaging for diagnostics.

It has been known to provide microscope slides with target areas for cellular samples, but such slides are generally produced using filters or paint. Approaches using filters or paint have drawbacks, particularly for screening, because these approaches yield samples in which the cells from the sample, intended for analysis, may be stacked on one another, thereby creating multiple focal planes. Such stacking reduces screening effectiveness and severely limits the practice of digital pathology, in which completed slides are scanned and transmitted electronically. A prepared slide with cells at multiple focal planes will be out of focus for some planes at any one time during analysis. Such slides are difficult to analyze individually and are difficult to analyze in an automated fashion.

In view of the foregoing, there is a need for improved methods and devices to reduce the layers of cells, cellular structures, and related materials, on a microscope slide to improve visibility on viewing platforms or devices for useful diagnostic analysis. Embodiments of the present invention may mitigate those challenges.

### SUMMARY

Some embodiments of the present invention are directed to microscope slides having two principle surfaces, formed of a glass material, wherein a portion of a first surface is treated, such as by chemical etching, or other related processing, to form one or more channels. These channels form one or more geometric shapes on the first surface. A portion of a second surface is also treated, such as by chemical, or other related processing, to form one or more channels. These channels form one or more geometric shapes on the second surface. In a preferred embodiment, the geometric shape(s) on the first and second surfaces are substantially identical to each other.

In an embodiment of the present invention, a sample or samples of cells, suitable for cytological study, are placed within the geometric shape on one surface of the slide.

In a preferred embodiment, the paths defined by the channels are closed and have no discrete ends. In this manner, the channels may form a closed geometric shape, such as for example a circle, an oval, a square, a rectangle, a hexagon, etc. or may substantially form such a closed geometric shape. The geometric shape is preferable symmetric along one or multiple axes perpendicular to the surfaces of the slide. Such symmetries, and the overall dimensions and area along the surfaces of the slide, may be selected to facilitate the computation of surface area for cytological analysis of the sample of cells.

The channels are preferably recessed with respect to surface of the slide. The depth of the channel is obtainable by known chemical etching or mechanical techniques, and may be, for example, from about 0.01 mm to about 0.3 mm, and specifically about 0.025 mm, about 0.05 mm, about 0.075 mm, about 0.1 mm, about 0.125 mm, about 0.15 mm, or 0.175 mm, about 0.2 mm, about 0.225 mm, about 0.25 mm, about 0.275 mm, or about 0.3 mm in depth, or other depth obtainable by such techniques. The channels are preferably of a defined, and consistent width, obtainable by known chemical etching or mechanical techniques, and may be, for example, from about 0.5 mm to about 2.5 mm in width, and specifically, about 0.5 mm, or 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 2.0mm, or about 2.5 mm in width, or other substantially uniform width obtainable by such techniques.

The dimensions of the channel, including the depth of the channel and the width of the channel, may be selected to facilitate the particular cytology method employed, based on the type and typical dimension of cells to be analyzed, and the carrier solution to be utilized. Certain depths and widths will be especially well suited to retaining a monolayer of cells within the geometric shape defined by the channel or channels.

In various embodiments, a microscope slide, as described, has etched channels forming one or more substantially identical, or substantially similar, geometric shapes (for example, a circle, an oval, a square, a rectangle, a hexagon, etc.) on each of the two principle surfaces of the slide. Such shapes form a target area for the placement of a sample, including for example a cell-containing solution, blood, plasma, or other fluid, on a first surface of the slide. The channel forming the geometric shape on the first surface of the slide serves to provide a gentle border to guide the specimen, cells, or fluid. The border may contain, fill or substantially fill with fluid from the sample, but does not receive a substantial portion of the cells to be analyzed. The geometric surface thus also serves to limit the normal distribution of cells into multiple layers that commonly occurs in microscopic slides known in the art.

The dimensions of the geometric shape, including the area (measured along the surface of the slide) or the shape, the symmetry of the shape, and the shape used, may be selected to facilitate the particular cytology method employed, based on the type and typical dimension of cells to be analyzed, and the carrier solution to be utilized. based on the type and typical dimension of cells to be analyzed, and the carrier solution to be utilized. Certain areas and symmetries and shapes will be especially well suited to retaining a monolayer of cells, and useful for certain sample volumes, within the geometric shape defined by the channel or channels. Certain shapes will facilitate counting and cytological analysis of the cells of the sample.

When the fluid of the sample fills the channel on the first surface of the slide, and the slide and sample are together covered by a cover slip, the index of refraction of the fluid and the slide may match, substantially masking the channel. Such masking makes it difficult or impossible to use the channel on the first surface as a visual guide in cytological analysis. The channel on the second, or reverse, side of the microscopic slide serves to provide an objective visual aid for measuring the adequacy of the specimen, cellular sample, or fluid. To the extend the channel on the second surface matches, or substantially matches, the channel on first surface, the channel can serve as a proxy to assist technicians (or automated detection mechanisms) in slide preparation, assists screeners (or automated or semi-automated screening devices) in assessing adequacy and cellularity of the sample, facilitate scanning of slides by both human (e.g., manually) and automated or digital scanning methods, and provide a orienting mark for automated screening technologies.

Thus, in preferred embodiments, the geometric shape defined by the channels on the first surface of the slide is matched by a similar, substantially similar or substantially identical geometric shape on the second surface of the slide. In such embodiments, the width of the channel on the first surface may be the same as the width of the channels of the second surface of the slide. In such embodiments, the width of the channel on the first surface may be different than the width of the channels of the second surface of the slide. In such embodiments, the depth of the channel on the first surface may be the same as the width of the channels of the second surface of the slide. In such embodiments, the depth of the channel on the first surface may different than the width of the channels of the second surface of the slide. Where the channel widths and/or depths differ on the two surfaces of the slide, the width and depth of the channels on the first surface of the slide may be selected to facilitate the monolayer-forming and sample retaining functions on the first surface or the slide, as described herein. Where the channel widths and/or depths differ on the two surfaces of the slide, the width and depth of the channels on the second surface of the slide may be selected to facilitate the optical functions of the channel, as described herein.

The microscopic slides of certain embodiments of the present invention, when used in a method of cytological analysis, permit the collection of analytical results utilizing fewer focal planes for the analysis of a given sample. When compared to finished slides (slides, cell samples and cover slips), methods using microscopic slides of the present invention require the analysis of no more than 90%, no more than 80%, no more than 75%, no more than 70%, no more than 60%, or no more than 50% or the focal planes required to conduct similar analysis of a given sample using currently commercially available microscopic slides.

The slides of the present invention can, in certain preferred embodiments, optionally be manufactured in a manner utilizing acids, or like substances, for etching the glass and alkaline, or like chemicals, for neutralizing the acid, or like substances.

Further aspects and features of the present invention will be apparent to persons of ordinary skill in the art, based upon the description provided herein.

### BRIEF DESCRIPTION OF THE DRAWINGS

Example embodiments disclosed herein are illustrated in the accompanying schematic drawings, which are for illustrative purposes only. The drawings are not necessarily drawn to scale, unless otherwise stated as such, or necessarily reflect relative sizes of illustrated aspects of the embodiments.

FIG. 1 schematically illustrates a microscopic slide according to one embodiment of the present invention.

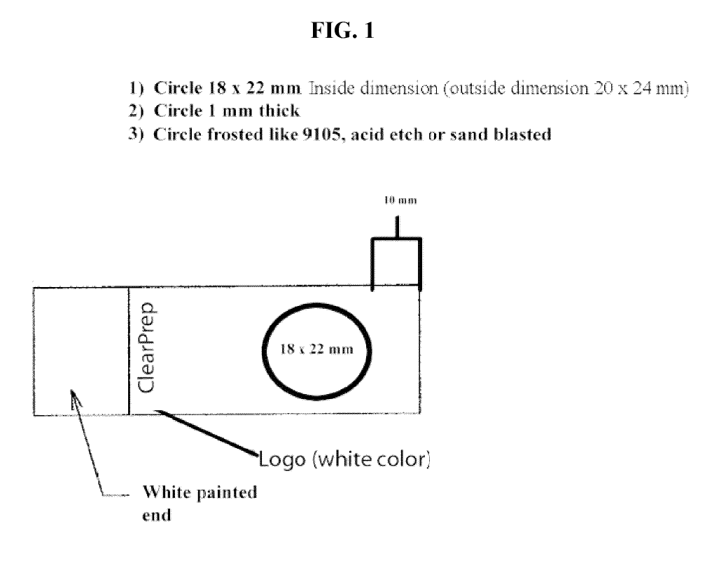

FIG. 2 depicts a perspective view of a microscopic slide according to one embodiment of the present invention.

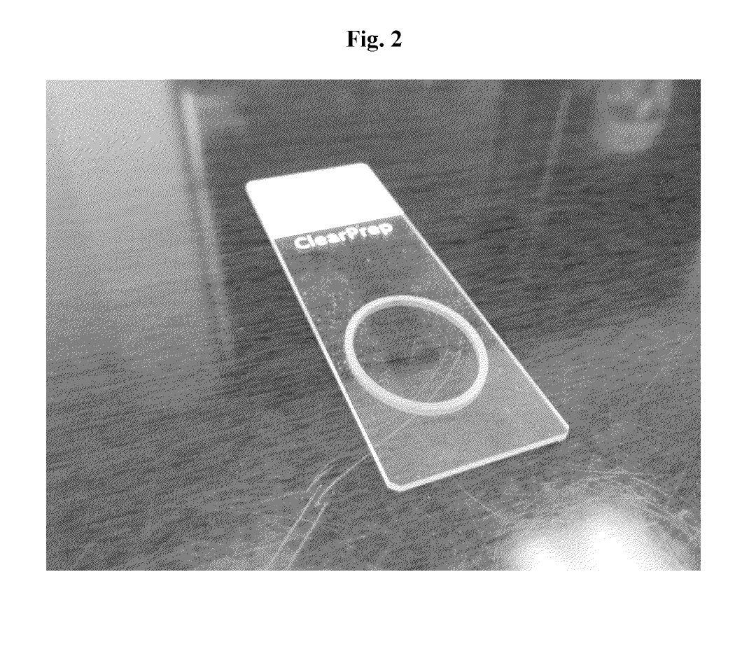

FIG. 3 depicts comparative data showing one improved aspect of an embodiment of the present invention. When compared to prior art microscopic slides, the microscopic slides of the present invention surprisingly require fewer focal planes to fully analyze a sample. The data show that significantly fewer focal planes are required when using the microscopic slides of the present invention for conducting cytology analyses of urine cell samples, oral cell samples, and cervical cell samples, than when using finished microscopic slides prepared using either a settling chamber or a filter.

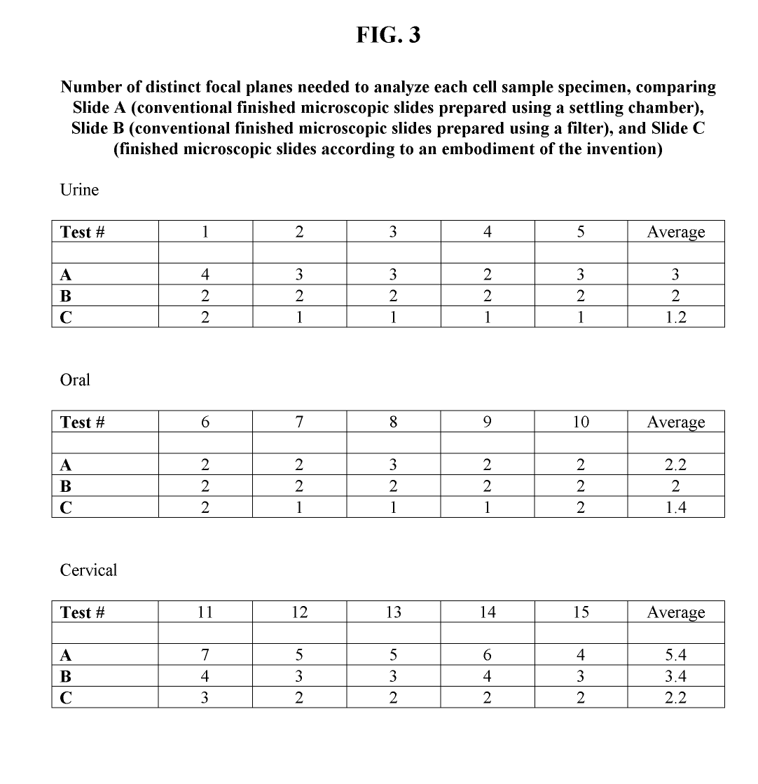

FIG. 4 depicts comparative data showing one improved aspect of an embodiment of the present invention. When compared to prior art microscopic slides, the microscopic slides of the present invention surprisingly require fewer focal planes to fully analyze a sample.

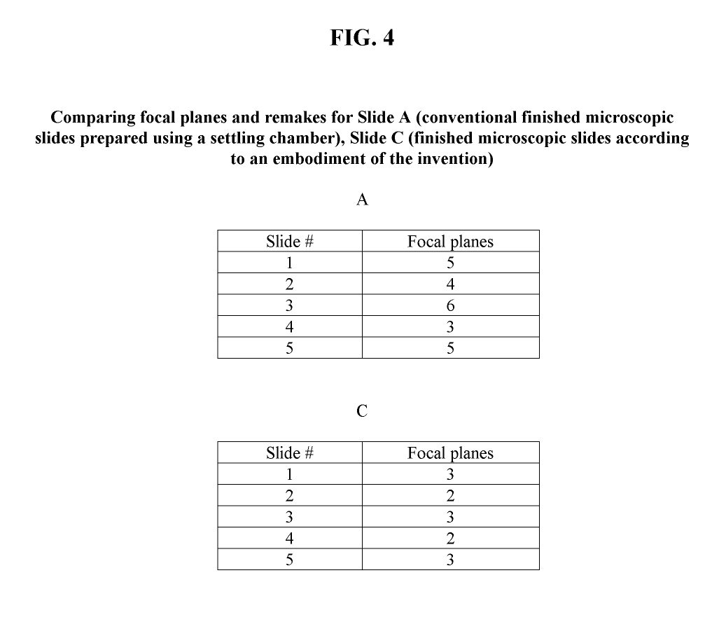

### DETAILED DESCRIPTION OF THE PREFERRED EMBODIMENTS

Described are improved methods and devices for processing, imaging, and diagnosing cells, cellular structures, and related material specimens.

Etching a geometric shape onto, for example, the obverse side of a slide, creates a target area that inhibits the stacking of cells, from a specimen to be analyzed, on one another. Indeed, individual cells or cell groups that are dispensed onto such an etched slide in, for example, a liquid slurry, have the opportunity to settle into their own place on the surface of the slide. This is extremely desirable as it creates a focal depth that is more amenable to accurate visual or digital examination of the specimen to be analyzed.

The etched geometric shape creates a ‘gentle’ border, creating a slight channel that can retain the sample but still inhibit the stacking of cells or other material that is intended for visualization and analysis.

When a sample has dried in known art slides a glass coverslip is typically applied. The thickness of the paint or filter can cause cellular stacking as well as clumping and thereby create multiple focal planes that impair accurate visual or digital examination of the specimen to be analyzed. Indeed, even the thickness of the paint causes the coverslip to sit on the paint rather than the surface glass, thereby creating multiple focal planes.

In embodiments of the invention, because the geometric shape has been etched rather than painted, or created by a filter, the coverslip will sit flush on the glass surface.

While the etching on the obverse side of the slide in the instant invention corrects for the inadequacies of the known art slides discussed above, a second issue can arise during the cover slipping process. During cover slipping applied adhesives or other fixatives can fill the etched shape and thereby obscure the etched shape and, accordingly, reduce the screening and orienting utility first provided by said shape. To address this problem, the instant invention provides for the etched geometric shape on the obverse side to be repeated on the reverse side of the slide. This dual etching embodiment, i.e. etching of a geometric shape on both sides of a slide, serves to render the geometric shape visible even after the slide and sample have been covered with a cover slip. A painted or silkscreened surface on the reverse would not work for this purpose, as such would render the slide unstable in the reviewing process.

The etched shape of specific dimension allows provides the screener an objective basis for computing adequate cellularity of a sample. This is done by computing the area inside the geometric shape, then using that area to determine the number of fields of view in the microscope, then dividing the required cells by the number of fields of view. In addition, the geographic shape of the etching serves as an orienting mark for automated screening technologies.

It is known that chemical (e.g. acid-based) etching can result in a residue remaining on slides, particularly when applied to both sides of the glass. Accordingly, a preferred embodiment of the instant invention is to provide for a manufacturing process comprising an alkaline-based neutralization step to neutralize or lessen said residue.

It is an object of certain embodiments of the present invention to provide a microscope slide that has an etched geometric shape (e.g. a circle, oval, square, rectangle, hexagon, etc.) on one, or both, surfaces of the slide. The etched shape on the obverse side of the slide inhibits the typical multiple focal planes that are commonly caused by cells, or like material, stacking or clumping together, where said stacking or clumping is common in known art slides. The etched shape on the obverse side decreases the number of focal planes in a given specimen to be analyzed and thereby increase the accuracy and ease of visual examination by both human and digital or automated means. The etched shape on the reverse side of the slide serves to render the geometric shape visible even after the slide has been coverslipped and thus provides increased visual orientation. The etched shapes also assist the laboratory technician in slide preparation, assist the screener in assessing adequacy of cellularity of the completed slide, facilitate scanning of slides by digital scanning apparatus, provide a critical orienting mark for automated screening technologies, and can be produced in a manner that utilizes an acid-based etching and an alkaline-based post-etching process to neutralize residues typically encountered in known art slides.

A microscope slide comprising: a body portion having a first surface and a second surfaces, each defining a plane, a segment of said first surface including a channel defining a geometric shape; a segment of said second surface including a channel defining a geometric shape which is substantially aligned with said geometric shape of the first surface.

Such a microscope slide wherein said channels are recessed into the slide with respect to the planes defined by the first and the second surfaces, respectively. The microscope slide of claim 1, manufactured using a chemical frosting or chemical etching process or manufactured using a chemical frosting or chemical etching process comprising both acid and alkaline components.

A microscope slide comprising: a body portion having upper and lower surfaces each defining a plane, a segment of said upper surface including a first frosted or etched geometric shape that is recessed within the plane of said upper surface; a segment of said lower surface including a second frosted or etched geometric shape which is aligned with said frosted or etched geometric shape of the upper.

A microscope slide having a top surface and a bottom surface, said top surface having at least a frosted or etched channel defining a geometric shape recessed within the slide with respect to the top surface, and the bottom surface having a channel defining a geometric shape recessed within the slide with respect to the bottom surface, the geometric shapes being substantially aligned with one another.

A microscope slide that provides an visual aid for measuring the adequacy of a cellular sample by having a top and bottom surface, said top surface having at least one frosted or etched geometric shape within said top surface to hold a cellular sample, said bottom surface having a frosted or etched geometric shape substantially aligned with said geometric shape on said top surface. Such a microscope slide, wherein said frosted or etched geometric shapes of the top surface are recessed with respect to the plane defined by said upper surface.

A microscope slide that provides facilitated scanning of a cellular sample by having a top and bottom surface, said top surface having at least one frosted or etched geometric shape within said top surface to hold a cellular sample, said bottom surface having a frosted or etched geometric shape substantially aligned with said geometric shape on said top surface

A method of visualizing a cellular sample comprising providing a microscope slide having a first surface and a second surface, said first surface having a channel defining a geometric shape and said second surface having a channel defining a geometric shape substantially aligned with said geometric shape on said first surface, applying a cellular sample to the first surface. applying a cover slip to the cellular sample, and detecting cells in the sample, by viewing through the cover slip. Such method further including a step of detecting the channel on the second surface. The method may be conducted by an automated system or a human.

A method of facilitating the scanning of a cellular sample comprising: providing a microscope slide having a top and bottom surface, said top surface having at least one frosted or etched geometric shape within said top surface to hold said cellular sample, said bottom surface having a frosted or etched geometric shape substantially aligned with said geometric shape on said top surface.

A method of facilitating a scanning of a cell-containing specimen for analysis purposes comprising receiving a cell-containing sample, contacting said cell-containing sample with the top surface of a microscope slide having a top and bottom surface, said top surface having at least one frosted or etched geometric shape within said top surface to hold said cellular sample, said bottom surface having a frosted or etched geometric shape substantially aligned with said geometric shape on said top surface; and executing an analysis of said cell-containing sample.

A method of visualizing a cell-containing specimen for analysis purposes comprising receiving a cell-containing sample; contacting said cell-containing sample with the top surface of a microscope slide having a top and bottom surface, said top surface having at least one frosted or etched geometric shape within said top surface to hold said cellular sample, said bottom surface having a frosted or etched geometric shape substantially aligned with said geometric shape on said top surface; and performing a visual analysis of said cell-containing sample. The method may be conducted by a human or an automated system.

A microscope slide which decreases the number of focal planes in a given specimen to be analyzed comprising: a body portion having upper and lower surfaces each defining a plane, a segment of said upper surface including a first frosted or etched geometric shape; wherein said frosted or etched geometric shapes are recessed with respect to the plane defined by said upper surface; a segment of said lower surface including a second frosted or etched geometric shape which is aligned with said frosted or etched geometric shape of the upper.

A manufacturing process for making the slide of claim 1, comprising an alkaline-based neutralization to reduce residue

Embodiments are described with reference to the figures, wherein like numerals refer to like elements throughout. The terminology used in this description is not intended to be interpreted in any limited or restrictive manner; it is being utilized for illustrative purposes in conjunction with a detailed description of certain embodiments. Furthermore, embodiments may include several novel features, and no single feature is solely responsible for its desirable attributes or is essential to practicing the embodiments herein described.

Through various embodiments, a slide is described by providing design features that address certain needs encountered in various cytology and related diagnostic methods. The foregoing description details certain embodiments. It will be appreciated, however, that no matter how detailed the foregoing appears in text, the described embodiments may be practiced in many other ways. As is also stated above, it should be noted that the use of particular terminology when describing certain features or aspects should not be taken to imply that the terminology is being re-defined herein to be restricted to including any specific characteristics of the features or aspects with which that terminology is associated.

What is claimed is:

1. A microscope slide comprising:
a body portion having a first surface and a second surfaces, each defining a plane,
a segment of said first surface including a first geometric shape;
a segment of said second surface including a second geometric shape which is substantially aligned with said first geometric shape of the first surface.

2. The microscope slide of claim 1 wherein said first and second geometric shapes are recessed into the slide with respect to the planes defined by the first and the second surfaces, respectively.

3. The microscope slide of claim 1, manufactured using a chemical frosting or chemical etching process.

4. The microscope slide of claim 1, manufactured using a chemical frosting or chemical etching process comprising both acid and alkaline components.

5. The microscope slide of claim 1, for providing a visual aid for measuring the adequacy of a cellular sample, wherein the first surface is a top surface, wherein the second surface is a bottom surface, wherein the first geometric shape on said top surface has at least one frosted or etched shape within said top surface to hold the cellular sample, and wherein the second geometric shape on said bottom surface has a frosted or etched shape substantially aligned with said first geometric shape on said top surface.

6. The microscope slide of claim 1, wherein said first and second geometric shapes are channels that are recessed with respect to a plane defined by the first surface.

7. The microscope slide of claim 1, for providing facilitated scanning of a cellular sample.

8. The microscope slide of claim 1, wherein the microscope slide is configured for providing an objective basis for computing adequate cellularity of a sample

9. The microscope slide of claim 1, wherein the microscope slide is configured for a manufacturing process comprising an alkaline-based neutralization to reduce residue.

10. A method of visualizing a cellular sample comprising:
providing a microscope slide having a first surface and a second surface, said first surface having a channel defining a geometric shape and said second surface having a channel defining a geometric shape substantially aligned with said geometric shape on said first surface,
applying a cellular sample to the first surface.
applying a cover slip to the cellular sample,
detecting cells in the sample, by viewing through the cover slip.

11. The method of claim 10, including the further step of detecting the channel on the second surface.

12. The method of claim 10, conducted by an automated system.

13. The method of claim 10, conducted manually by a human.

14. The method of claim 10, further facilitating the scanning of the cellular sample.

15. The method of claim 10, wherein the cellular sample forms one layer of cells.

16. The method of claim 10, wherein the cellular sample forms two or less layers of cells.

17. A method of facilitating a scanning of a cell-containing specimen for analysis purposes comprising:
receiving a cell-containing sample;
contacting said cell-containing sample with the top surface of a microscope slide having a top and bottom surface, said top surface having at least one frosted or etched geometric shape within said top surface to hold said cellular sample, said bottom surface having a frosted or etched geometric shape substantially aligned with said geometric shape on said top surface;
and executing an analysis of said cell-containing sample.

18. The method of claim 17, wherein the microscope slide is configured for providing an objective basis for computing adequate cellularity of a sample.

19. The method of claim 17, wherein the geographic shape serves as an orienting mark for an automated screening technology.

20. The method of claim 17, further comprising reducing residue through application of an alkaline-based agent for neutralization.
